(19) United States
(12) Patent Application Publication
(10) Pub. No.: US 2022/0138683 A1
(43) Pub. Date: May 5, 2022

(54) Property Inventory Tracking

(71) Applicant: Wells Fargo Bank, N.A., San Francisco, CA (US)

(72) Inventors: Basil F. Nimry, Des Moines, IA (US); Ankush Bhatia, Waukee, IA (US); Dale Steven Howard, Clive, IA (US); Jan M. Emter, Minneapolis, MN (US); Wesley Damon Brown, West Des Moines, IA (US)

(21) Appl. No.: 15/824,707

(22) Filed: Nov. 28, 2017

(51) Int. Cl. G06Q 10/08; G06Q 30/00; H04L 12/28; G06Q 10/06; G06Q 30/02; G06F 3/0481

(52) U.S. Cl. CPC G06Q 10/0875; G06Q 30/012; G06Q 30/0207; G06Q 10/06; G06F 3/0481; H04L 12/2823

(57) ABSTRACT

A method implemented on an electronic computing device includes obtaining an inventory of items in a property. Financial information is associated with one or more of the items. A status is monitored regarding maintenance and recalls of one or more of the items. Based on the status and using the financial information, at least one recommendation is provided for maintenance or replacement of one or more of the items.

### BACKGROUND

Individuals who own a property typically purchase many items during the course of owning the property. Examples can include a furnace, a roof, siding, windows, a central air conditioner, appliances, furniture, carpeting, televisions, computers and other items. Over a period of time, the individuals may lose track of or forget about some of the items that they purchased.

Purchased items typically have a life expectancy. Different items can have different life expectancies. In addition, many items can breakdown and require maintenance and repairs during their life.

### SUMMARY

Embodiments of the disclosure are directed a method implemented on an electronic computing device for maintaining a property inventory, the method comprising: obtaining an inventory of items in a property; associating financial information with one or more of the items; monitoring a status regarding maintenance and recalls of one or more of the items; and based on the status and using the financial information, providing at least one recommendation for maintenance or replacement of one or more of the items.

In another aspect, a method implemented on an electronic computing device for determining a status of inventoried items in a home comprises: obtaining an inventory of items in the home; obtaining purchase information for one or more of the items; obtaining a maintenance history for one or more of the items; monitoring an operational status of one or more of the items; and based on the purchase information, the maintenance history and the operational status, determining a health score for the home, the health score representing a condition of the items in the home.

In yet another aspect, an electronic computing device comprises: a processing unit; and system memory, the system memory including instructions which, when executed by the processing unit, cause the electronic computing device to: obtain an inventory of items in a home; associate financial information with one or more of the items, the financial information comprising one or more of warranty information, purchase price of the item and replacement cost of the item; monitor an operational status of one or more of the items; based on the operational status and using the financial information, provide at least one recommendation for maintenance, replacement or upgrade of one or more of the items; calculate an individual health score for one or more of the items, the individual health scores representing a condition of the respective items of the one or more of the items; and apply weighting factors to the individual health scores for each of the plurality of the items to determine an overall health score for the home.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports property inventory tracking.

FIG. 2 shows example modules of the server computing device of FIG. 1.

FIG. 3 shows an example user interface screen that can be used for property inventory tracking.

FIG. 4 shows another example user interface screen that can be used for property inventory tracking.

FIG. 5 shows yet another example user interface screen that can be used for property inventory tracking.

FIG. 6 shows yet another example user interface screen that can be used for property inventory tracking.

FIG. 7 shows yet another example user interface screen that can be used for property inventory tracking.

FIG. 8 shows an example method for implementing property inventory tracking.

FIG. 9 shows an example method for determining health scores for inventoried items and for a property.

FIG. 10 shows example physical components of the server computing device of the system of FIG. 1.

### DETAILED DESCRIPTION

The present disclosure is directed to systems and methods for property inventory tracking. Using the systems and methods, a plurality of items in a property can be inventoried and information can be stored regarding each item. The information can include a purchase date for the item, a purchase cost, warranty information and maintenance information, including a maintenance history. In addition, other financial information can be stored for each item, including any offers made by a financial institution of incentives or deals to repair or replace an item.

As used in this disclosure, property can refer to a home, such as a house, condominium or other structure, in which one or more people can reside. The property can also be a commercial building.

The systems and methods also provide for a digital dashboard in which an individual can view the stored information for each of the items. The digital dashboard can also display a summary of a health status of the property and many of the items. The health status can include an overall score that can represent an overall condition of the items in the property. The digital dashboard can also provide a health status of a condition of individual items or categories of items in the property. In addition, the digital dashboard can provide recommendations for repairing or replacing items and for offers, incentives and deals for repairing or replacing items.

The systems and methods provide for multiple ways for inventorying items, including manual entry of item information and scanning an item. For example, information for each item can be manually entered into an electronic computing device. Items can also be inventoried by scanning an image of the item with a camera on a smartphone, augmented reality headset or other device. Additional information regarding an item, such as warranty, product and incentive offers can be obtained from one or more third-party sources.

The systems and methods disclosed herein are directed to a computer technology that maintains an inventory of property items and associates financial information with each of the property items. The financial information can help a property owner determine an optimum time to replace an item or to determine when to repair an item instead of replacing the item. The systems and methods can also calculate health scores for individual items and for categories of items and can calculate an overall health score for the property.

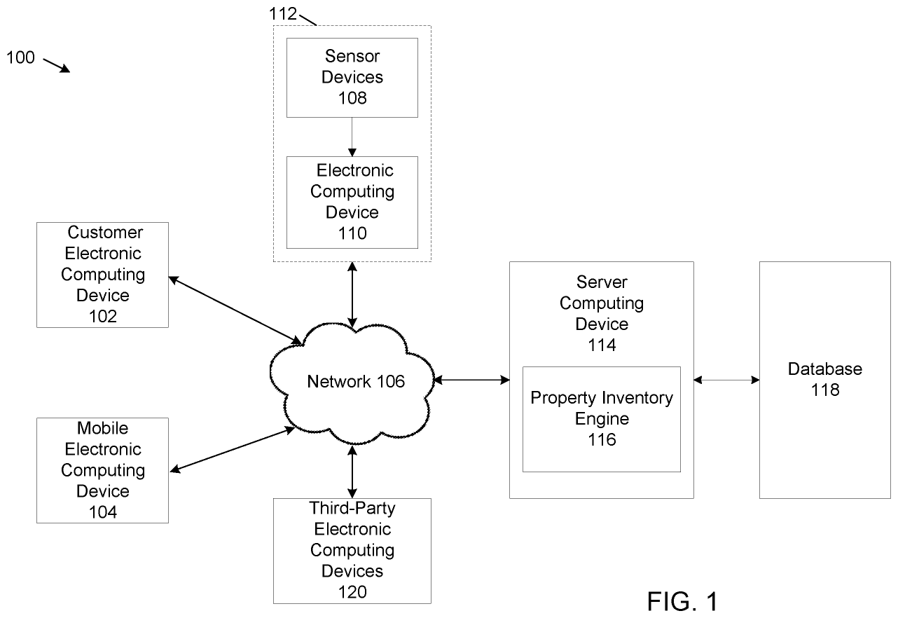

FIG. 1 shows an example system 100 that can support property inventory tracking. System 100 includes customer electronic computing device 102, mobile electronic computing device 104, network 106, property 112, server computing device 114, database 118 and third-party electronic computing devices 120. Property 112 includes sensor devices 108 and electronic computing device 110. Server computing device 114 includes property inventory engine 116. More, fewer or different components are possible.

The example customer electronic computing device 102 is a desktop computer, laptop computer, tablet computer, smartphone or any other computing device of an individual for which items in a property of the individual are inventoried. The individual can be a customer of an organization that can inventory items in the property for the individual. The individual can use customer electronic computing device 102 to access server computing device 114 to manually input data regarding the items and to display a digital dashboard containing details regarding the inventoried items.

The example mobile electronic computing device 104 is a mobile electronic computing device of the individual, for example a smartphone or a tablet computer. The individual can use a camera on mobile electronic computing device 104 to scan an item that is to be inventoried and to send an image of the item to server computing device 114. The mobile electronic computing device 104 can also be used in a similar manner as customer electronic computing device 102 to manually enter items to be inventoried and to access the digital dashboard. In some implementations, mobile electronic computing device 104 can be an augmented reality (AR) device such as an AR headset. Items to be inventoried can be scanned via the AR headset, in a manner similar to that described in U.S. patent application Ser. No. 15/346,344, entitled “Augmented Reality Value Advisor,” filed on Nov. 8, 2016, the entirety of which is incorporated herein by reference. One type of AR headset is a smart glass type of headset, similar to eyeglasses that may be worn by the user. The user may view AR images in the glass portion of the headset. An example of a smart glass headset is Google Glass, from Google Inc. of Mountain View, Calif.

In addition to customer electronic computing device 102 and mobile electronic computing device 104, in some implementations information regarding some of the items can be automatically entered into server computing device 114. For example, information regarding some items installed by a builder of the property, for example a driveway, can be automatically supplied or submitted from a computer system of the builder to server computing device 114.

The example network 106 is a computer network and can be any type of wireless network, wired network and cellular network, including the Internet. Customer electronic computing device 102, mobile electronic computing device 104, electronic computing device 110 and third-party electronic computing devices 120 can communicate with server computing device 114 using network 106.

The example property 112 is a property of the individual that contains items that can be inventoried. Property 112 includes sensor devices 108 and electronic computing device 110. Sensor devices 108 include one or more sensors that can be attached to items such as a furnace, air conditioner and appliances to capture status information regarding the items. The status information can include usage data, maintenance data and operational data. Other status information is possible. Data from sensor devices 108 are sent to electronic computing device 110 which in turn can send the sensor data to server computing device 114. Sensor devices 108 can also be Internet of Things (IOT) devices that can transfer data directly over network 106 to server computing device 114. Sensor devices 108 can also transfer data using a wireless technology such as Bluetooth. Additional details regarding using sensors in a property to capture status information of items in the property is described in U.S. patent application Ser. No. 15/492,355, entitled “Virtual Property Appraisals and/or Inspections,” filed on Apr. 20, 2017, the entirety of which is incorporated herein by reference.

The example server computing device 114 is a server computing device of an organization, for example a financial institution such as a bank, that can process the inventory data using property inventory engine 116. More than one server computing device 114 can be used.

The example property inventory engine 116 processes received inventory data and inventories items based on the received inventory data. Property inventory engine 116 can also register items with a manufacturer of the item for warranty purposes, monitor inventoried items for required maintenance, determine whether any malfunctioning items can be covered under a warranty for the item and calculate an overall health score and additional health scores for individual or functional groupings of items.

The example database 118 is a database associated with the organization of server computing device 114. Database 118 can store information regarding items in the property that are inventoried. The information can include identification information, warranty information, maintenance information, recall history, repair resources and health scores. Other information is possible. Server computing device 114 can store all or parts of the information in database 118 using various methods, such as a blockchain recording system. Database 118 can be distributed over a plurality of databases. Server computing device 114 can be programmed to query (e.g. using Structured Query Language, SQL) database 118 to obtain the customer information.

An example schema including, but not limited to, inventory information stored in database is shown below:
Customer ID—a set or letters, numbers or other symbols that uniquely identifies a customer;
Item ID—a set of letters, numbers or other symbols that uniquely identifies an inventoried item;
Property Location ID—a set of letters, numbers or other symbols that uniquely identifies a property where the inventoried items are located; can be a global positioning system (GPS) coordinate;
Item Description—a textual description of the inventoried item;
Date of Purchase—a purchase date of the inventoried item;
Purchase Price—purchase price of the inventoried item;
Replacement Cost—a current cost of replacing the inventoried item;
Warranty Record Pointer—a pointer to a record of warranty information and repairs for the inventoried item;
Recall Record Pointer—pointer to a record of a recall history for the inventoried item;
Maintenance Record Pointer—a pointer to a record of a maintenance history for the inventoried item;
Operational Status Record Pointer—a pointer to a record on operational status information for the inventoried item;
Recommendation Pointer—a pointer to a record of recommendations for maintenance or replacement for the inventoried item;

The above schema permits the database to be queried for data such as dates and descriptions of warranty service, dates and descriptions of maintenance, operational status data and other items. The schema can be bundled as a container so that the schema can be easily transferred, for example between property owners.

As an example, the following messaging format can be used between the server computing device 114 and the database 118 to obtain warranty service performed on a specific inventoried item.

| | | |
|---|---|---|
| Customer ID | Item ID | Maintenance Record |

As an example, the database 118 can use the following messaging format in responding to such a request.

| | | | | |
|---|---|---|---|---|
| Customer ID | Item ID | Date of first | Description of | . . . |
| | | maintenance | first maintenance | |
| | | service | service | |

The response message can include many additional fields depending on how many maintenance service calls or recalls were made for the item. Similar message formats can be used for other fields. For example for operational status data, “Operational Status” can be substituted for “Maintenance Record” above. Example response fields for operational status can include customer ID, Item ID, hours used, energy usage, and last time operated. More, fewer, or different fields can be used. Other examples are possible.

The example third-party electronic computing devices 120 are electronic computing devices, for example server computing devices and databases from a variety of sources, that help implement a process of inventorying property items. For example, one or more of the server computing devices and databases can be from manufacturers of the items than can register the items for warranty purposes and that can provide product updates and announcements for the items. Other electronic computing devices and databases can be electronic computing devices from organizations or individuals that can provide repairs for one or more of the items. Still other electronic computing devices and databases can be from organizations that can offer financial incentives to repair or replace one or more of the items.

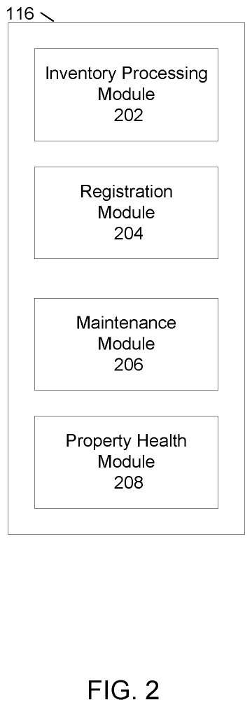

FIG. 2 shows example modules of property inventory engine 116. The example modules include an inventory processing module 202, a registration module 204, a maintenance module 206 and a property health module 208. More, fewer or different modules are possible.

The example inventory processing module 202 receives scanned or manually entered inventory information regarding items in the property and processes the inventory information. Inventory information can include a description and other information regarding the item and can also include a geolocation (e.g. a GPS location) for the property in which the items are located. Items can be geo-tagged with the geolocation. The geo-tag for an item can help identify a replacement or repair cost for an item. For example, an appliance in Hawaii typically costs more than an appliance in Iowa.

Processing the inventory information comprises parsing and storing manually entered inventory information. Processing the inventory information also comprises extracting the inventory information from scanned images of items and then storing the inventory information. The inventory information can be stored in database 118.

Fields of inventory information that can be parsed or extracted and stored can comprise a description of the item, a purchase date of the item, a purchase price of the item, a person, company or online shopping site from which the item was purchased, a geo-tag for the item, an identifier for an organization (typically a company from which the item was purchased) that offers a warranty for the item, a classification type for the item (e.g. furnace, appliance, etc.) and a photo of the item. The inventory information can also include a universal product code (UPC), quick response code (QRC) or other identifier for the item. For scanned items, some of the information (for example a price of the item) can be obtained by comparing an image of the item with images of known items. For example, the scanned image of the item can be sent to one of third-party electronic computing devices 120 and compared with a database of known similar objects. When the organization corresponding to server computing device 114 is a financial institution and the individual is known to have purchased the item using a payment card for the financial institution, the purchase date of the item may be able to be obtained from the financial institution. Any other item information that cannot be obtained from a scanned image can be requested of the individual by server computing device 114. In addition to scanned property items, receipts, warranty cards, and similar items can also be scanned.

The inventory processing module 202 can also keep track of items that are purchased, repaired or sold during the course of owning the home. This information can be transferred to a new owner when the item or the home is sold. Inventor processing module 202 can also access maintenance information from maintenance module 206 regarding the item or the home. The maintenance information can include maintenance, repair and warranty related information.

The example registration module 204 processes requests to register the inventoried item for warranty purposes or to obtain warranty information for already registered items. Registration module 204 can access database 118 for information about the item, such as an item identifier, date of purchase, place of purchase and receipt related information, that can be used to determine whether the item has been registered. When a determination is made that the item has been registered, warranty information can be obtained from a third-party electronic computing device 120 that is accessed. When the determination is made that the item has not been registered and still can be registered, registration module 204 can register the item. The third-party electronic computing device 120 can be a manufacturer of the item or an organization designated by the manufacturer of the item to service warranty requests.

The example maintenance module 206 keeps track of any maintenance that has been performed on the inventoried items. This includes receiving and storing descriptive records in database 118 of any new maintenance performed on the item. New maintenance can include both repairs and preventative maintenance. When a maintenance record for an inventoried item does not already exist, maintenance module 206 can store a maintenance history of the item. The maintenance history for the item, if known, can be provided by the property owner as can a descriptive record of new maintenance performed on the item. In addition, for items that are under warranty, maintenance module 206 can provide information regarding an availability of extending the warranty, can provide offers to extend the warranty and can provide information regarding an availability of replacement parts.

When repairs for an item are called for, maintenance module 206 can access the registration module 204 to determine whether the item is still under warranty. If the item is still under warranty, maintenance module 206 can obtain information as to where to send the item for warranty repairs. Maintenance module 206 can inform the property owner of how to obtain warranty repairs. When the item is not under warranty, maintenance module 206 can also access database 118 to obtain any information regarding any recommended individuals or organizations for repairing the item.

When repairs are called for and the item is not under warranty, maintenance module 206 can help the property owner determine whether it makes financial sense to repair the item or whether it would be better to replace the item. Maintenance module 206 can access database 118 to determine when the item was purchased and to obtain a history of maintenance performed for the item. Maintenance module 206 can also access one of third-party electronic computing devices 120 (for example a web site that provides information on cost of replacement products) to determine a replacement cost for the item. Maintenance module 206 can then provide the property owner with a recommendation as to whether to repair or replace the item.

In some implementations, maintenance module 206 can include an artificial intelligence (AI) engine that can automatically make the recommendation based on the maintenance history, age of the item, cost of a replacement item and other factors such as a financial status of the property owner (what the property owner can currently afford to pay), the age of the property owner, how long the owner intends to keep the property and other factors.

Maintenance module 206 can also access websites (third-party electronic computing devices 120) of manufacturers of the items in the property to sign the property owner up for product announcements regarding updates to the items and possible recalls of the item. Once signed up, the manufacturers can send the products announcements directly to the property owner.

Maintenance module 206 can also provide information regarding financial assistance for any upgrades or replacements for items in the home and for any financial incentives for replacing an aging appliance or inventory in the home. In some cases, the financial assistance or incentives can be tied to the geolocation of the home. For example, homes that are in particularly noisy areas, for example near an airport or in an airplane flight path, may qualify for a financial incentive to noise proof windows in the home.

The example property health module 208 can calculate an overall health score of the property as well as health scores for selected items or categories of items in the property. The overall health score can represent a number (for example from 1 to 100) that represents a condition of the inventoried items in the property. A high score (for example with 100 being the highest) can indicate that inventoried items in the property are relatively new and in good condition. A low score can indicate that some of the items are in need of repair or replacement. Individual items and categories of items can have separate health scores and can include the furnace, siding, air conditioning, driveway and appliances. The overall health score and the health score for the selected items and categories can be displayed on a digital dashboard, discussed in more detail later herein.

The overall health score of the property can be determined by determining health scores for individual items and applying weighting factors. In an example implementation, each individual item can be given an initial score of 100 and points can be taken off for age and repairs. An estimated lifetime can be established for each item and points related to age can be deducted for each year of life. For example, for a roof with a 20-year lifetime 5 points can be deducted for each year (100/20). In addition, points can be deducted for repairs made to the roof. As an example, a roof that is 12 years old that had repairs resulting in a 10-point deduction can have a health score of 30 (100−(12*5)−10).

Weighting factors can be applied to individual health scores to calculate an overall health score for the property. The weighting factors can be implementation dependent. Table 1 below shows example weighting factors that can be applied to individual health scores to calculate an overall health score for the property. The sum of all weighting factors is 100%. Other weighting factors and options are possible. For example, weighting factors can be provided for an age of the property and for a geolocation of the property.

TABLE 1

| Health Score Item | Weighting |
|---|---|
| Roof | 15% |
| Siding | 10% |
| Windows | 15% |
| Furnace | 10% |
| Air Conditioner | 5% |
| Appliances | 15% |
| Driveway | 10% |
| Other | 20% |

The health score for the property and the health scores for the individual items can also be assigned to a category that describes the condition of the property and the individual items. Based on a numerical health score scale from 1 to 100, the numerical health scores can be translated into a descriptive condition of the property as shown in table 2. Other translations are possible.

TABLE 2

| Health Condition | |
|---|---|
| Category | Health Score |
| Excellent | 76-100 |
| Good | 51-75 |
| Fair | 26-50 |
| Poor | 0-25 |

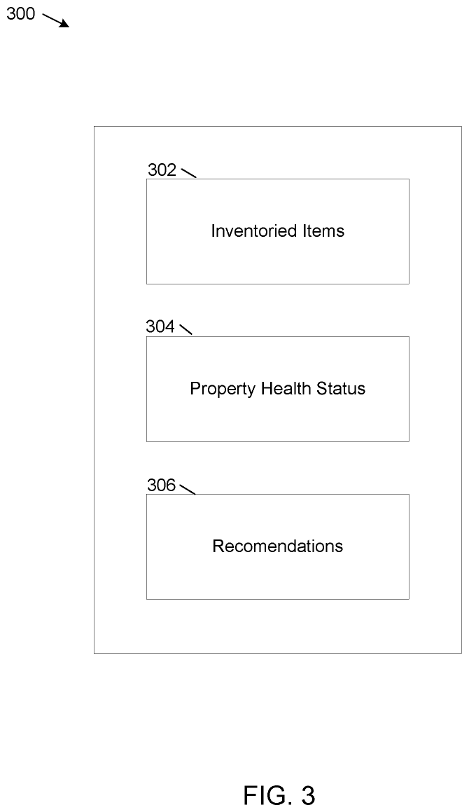

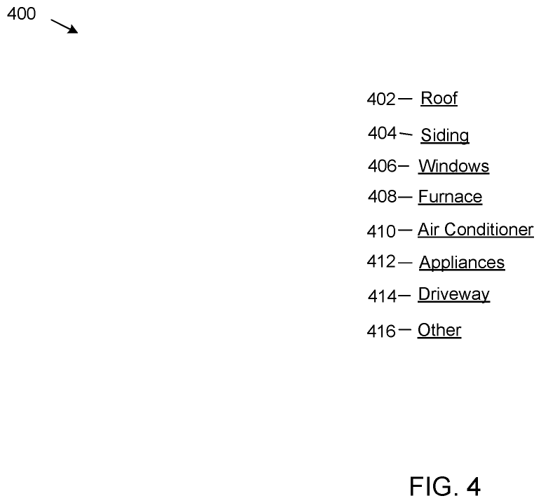

FIG. 3 show an example user interface screen 300 than can be displayed on a software application on a smartphone (mobile electronic computing device 104) of the property owner. User interface screen 300 can be displayed when the property owner selects the software application on the smartphone. User interface screen 300, as well as user interface screens described in FIGS. 4-7 later herein, comprise the digital dashboard for system 100. The user interface screens shown in FIGS. 3-7 provide for a structured display of various types of information regarding inventoried items in the property. This permits a property owner to easily view a status of the inventoried items.

User interface screen 300 includes buttons for inventoried items 302, property health status 304 and recommendations 306. Selecting inventoried items 302 permits a display of information regarding items that are inventoried in the property. Selecting property health status 304 permits a display of an overall health status of the property and a health status of individual items and categories of items in the property. Selecting recommendations 306 permits a display of recommendations regarding whether items in the property should be repaired or replaced.

FIG. 4 shows an example user interface screen 400. User interface screen 400 is displayed when the selected inventoried items 302 button of FIG. 3 is selected. User interface screen provides links to display information regarding inventoried items and categories of inventoried items for the property. Example inventoried items and categories include the roof 402, siding 404, windows 406, furnace 408, air conditioner 410, appliances 412, driveway 414 and other 416. More, fewer and different items and categories are possible. When any inventoried item is selected, a user interface screen is displayed providing information regarding the inventoried item. The information can include such things as date of purchase, warranty information and maintenance history. When any categories are selected, individual items within the category can be selected. For example, when appliances 412 are selected, the property owner can select individual appliances such as refrigerator and washing machine. The property owner can then select the individual appliance to display information regarding the selected appliance.

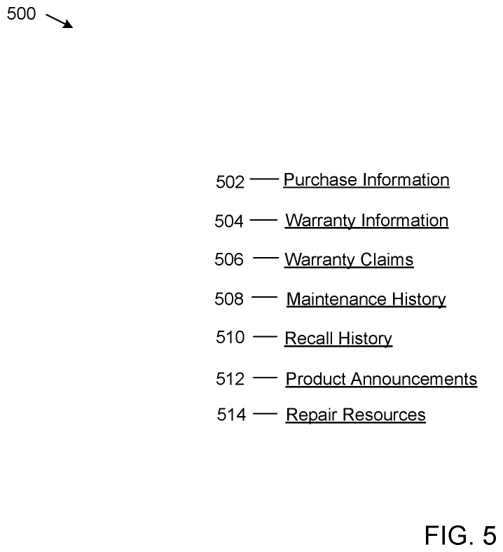

FIG. 5 shows an example user interface screen 500. User interface screen 500 is displayed when an item from user interface screen 400 is selected or when an item of a category, such as appliances 412, is selected. The example user interface screen 500 includes links for purchase information 502, warranty information 504, warranty claims 506, maintenance history 508, recall history 510, product announcements 512 and repair resources 514. More, fewer or different items are possible on user interface screen 500.

When a link on user interface screen 500 is selected, information associated with the selected link is displayed. When purchase information 502 is selected, information including a description of the item purchased, a date of purchase, a place of purchase and a cost of the purchased item can be displayed. When warranty information 504 is selected, a date of warranty expiration can be displayed. When warranty claims 506 are selected, a description of any warranty claims made for the item can be displayed. When maintenance history 508 is selected, a description of any maintenance performed on the item can be displayed. The maintenance can include both preventative maintenance, such as a date of replacement of furnace filters and a repair/replace history for the item. When recall history 510 is selected, a description of any recalls for the item can be displayed. When product announcements 512 are selected, a description of any announcements regarding product updates or recalls can be displayed. When repair resources 514 is selected, a listing of individuals or organizations than can provide repairs for the item can be displayed. The listing of the individuals or organizations can be obtained based on individual recommendations and from websites (e.g. Angie's List), one or more of third-party electronic computing devices 120 that can provide such recommendations.

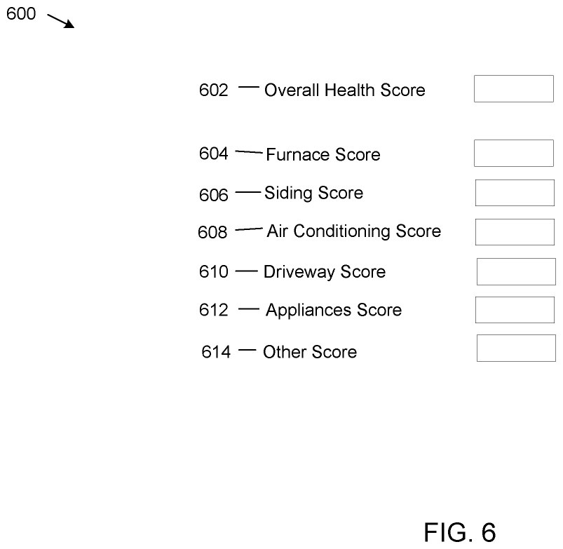

FIG. 6 shows an example user interface screen 600 that can provide information regarding health scores for the property. User interface screen 600 is displayed when property health status 304 of FIG. 3 is selected. User interface screen 600 can display an overall health score 602 for the property. User interface screen 600 can also display health scores for individual inventoried items and categories of inventoried items including a furnace score 604, a siding score 606, an air conditioning score 608, a driveway score 610, an appliances score 612 and an other score 614. The other score 614 comprises a health score for other items or categories of items that can include such items as property computers, entertainment systems, sump pumps, lawn mowers, snow blowers, motor vehicles and other items and/or categories.

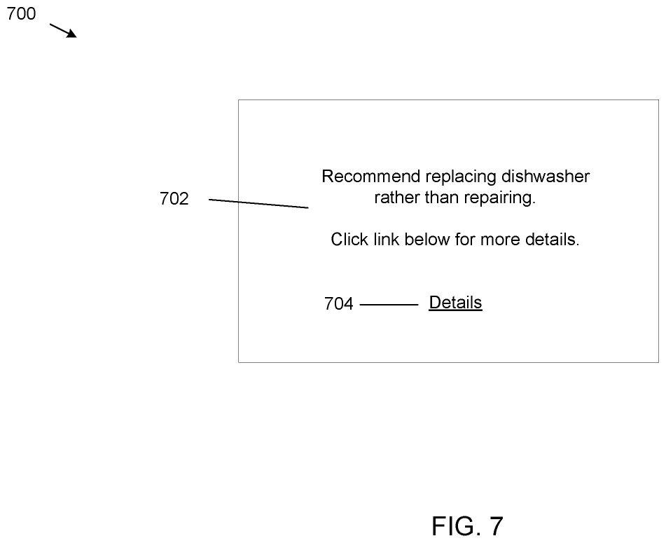

FIG. 7 shows an example user interface screen 700 that can provide recommendations regarding whether to repair or replace an item that is in need of maintenance. Maintenance module 206 can make a determination as to whether to repair or replace an item, as discussed earlier herein. User interface screen 700 shows an example recommendation 702 that can be displayed. The example recommendation 702 is to replace a dishwasher rather than to repair the dishwasher. Recommendation 702 also includes that details can be provided by clicking a link below. When details link 704 is selected, an explanation for the recommendation can be displayed. For example, the recommendation (not shown) can indicate that because of the age of the dishwasher, previous repairs to the dishwasher and the estimated cost of a current repair to the dishwasher, it would be better to purchase a new dishwasher than to repair the current dishwasher. When replacement parts are unavailable, for example because the dishwasher is a discontinued product, the explanation can also indicate that replacement parts are unavailable due to a discontinued product.

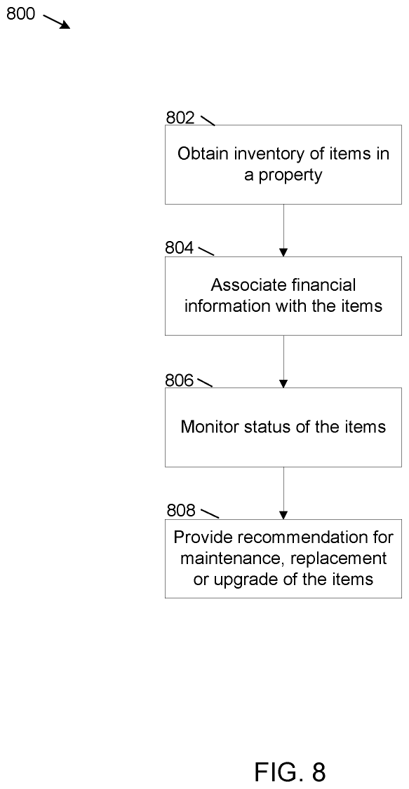

FIG. 8 shows a flowchart for an example method 800 implemented on server computing device 114 for property inventory tracking.

At operation 802, an inventory of items in a property is obtained. The inventory can be obtained by manually entering data regarding the items into an inventory application on a customer computing or a smartphone or by scanning an image of the item using the smartphone. Items entered into the inventory application can be sent to a server computer and stored in a database. In addition, IOT devices can automatically add or update inventory records for items.

The property items to be inventoried can include a roof, siding, furnace, air conditioner, driveway, appliances, electronic devices such as computers and personal electronics and other items that can be inventoried. Some examples of other items can include furniture, draperies, carpeting, windows, jewelry and personal items. Still other items that can be inventoried are possible.

At operation 804, financial information is associated with one or more of the inventoried items. The financial information can include such things as a purchase date for an item, a purchase cost, warranty information, maintenance information and available offers and incentives, manufacturer's rebates or energy company rebates for purchasing a replacement item.

At operation 806, the operational status of some items is monitored. For example operational status can be monitored for such items as appliances, a furnace, an air conditioner and any similar item that uses energy. Examples of operational status for these devices can include hours used, energy usage and last time operated.

The operational status can be automatically monitored via sensor devices attached to or associated with one or more of the items. For example, the sensors can be Internet of Things (IOT) sensors that can send status information to an electronic computing device in the property, similar to electronic computing device 110. The electronic computing device can then send the status information to the server computer or can be polled by the server computer for the status information.

At operation 808, recommendations can be provided for maintenance, replacement or upgrade of inventoried items. The recommendations can be based on an analysis of operational status, warranty coverage, maintenance history, age of an item, replacement cost of an item and other factors. One example recommendation can be to repair the item. Another example recommendation can be to replace the item. A third example recommendation can be to take advantage of an incentive program, manufacturer's rebate or energy company rebate to purchase a similar item under the incentive program.

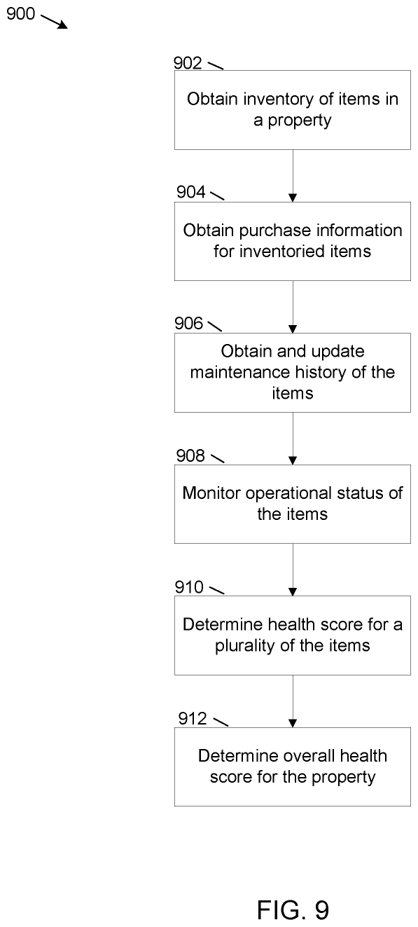

FIG. 9 shows a flowchart for an example method 900 implemented on server computing device 114 for determining health scores for the property. An overall health score for the property can represent an overall condition of the property. A health score for individual inventoried items in the property or categories of items, such as appliances, can represent the overall condition of the items or categories.

At operation 902, an inventory of items in the property is obtained either by manually entering inventory information or by scanning an image of each inventoried item. This operation is the same as operation 820 of FIG. 8.

At operation 904, purchase information is obtained, if available, for the inventoried items. The purchase information can include a date of purchase, a purchase price, name and address information for an individual or entity from which the item was purchased and warranty information regarding the item. Other purchase information is possible. The purchase information can be obtained by manually entry by the property owner or other knowledgeable individual and from one or more of third-party electronic computing devices 120.

At operation 906 a maintenance history of the items in the property are obtained from database 118. The maintenance can include both preventative maintenance, such as a date of replacement of furnace filters and a repair/replace history for the item.

At operation 908, property inventory engine 116 monitors the operational status of each of the inventoried items in the property. Monitoring the operational status can comprise obtaining operational information from sensor devices that can be included with one or more of the items. The operational information can include things like hours used and energy usage. Operational information can also be obtained by manual entry by the property owner or family member of the property owner or by a repair/maintenance technician.

At operation 910, a health score is determined for a plurality of inventoried items or categories of items. The health score can represent an overall condition of the inventoried items or category of items. Inventoried items or category of items that are new or in good condition can receive a high health score. Inventoried items or category of items that are older and that have had extensive repairs can receive a low health score. Categories of item can include categories such as appliances and personal electronics. The health score can also be determined by an age of the property and a geolocation of the property.

At operation 912, an overall health score for the property is determined. The overall health score for the property is derived from the health scores for the plurality of items and categories. Weighting factors can be used for each individual health score or category of health scores. For example, health scores for a roof and siding can be given a higher weighting than a health score for an air conditioner, because of the relative importance and replacement costs for the roof and siding.

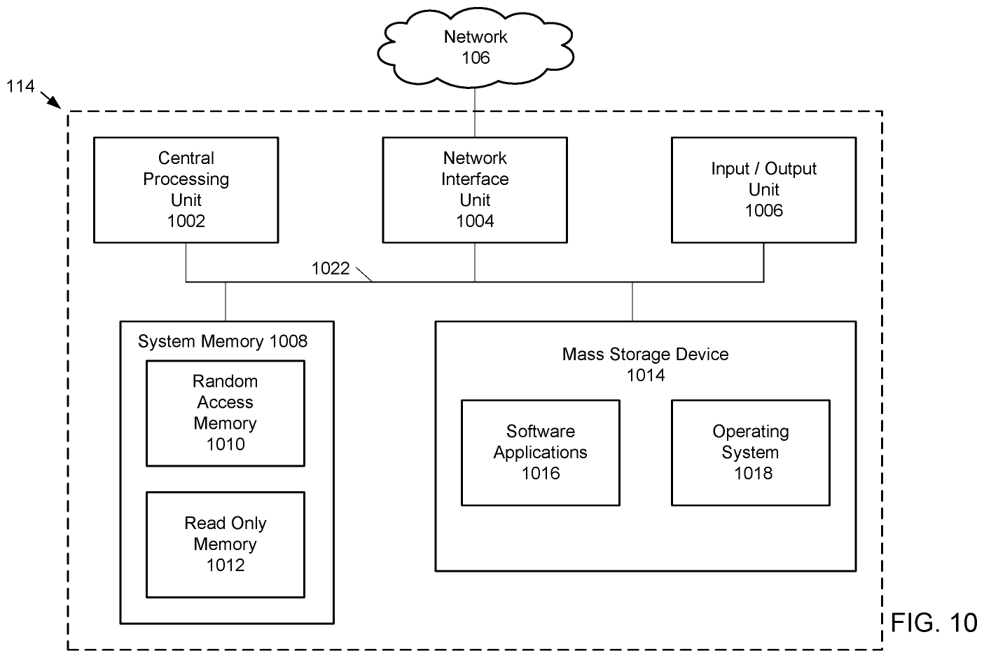

As illustrated in the example of FIG. 10, server computing device 114 includes at least one central processing unit (“CPU”) 1002, also referred to as a processor, a system memory 1008, and a system bus 1022 that couples the system memory 1008 to the CPU 1002. The system memory 1008 includes a random access memory (“RAM”) 1010 and a read-only memory (“ROM”) 1012. A basic input/output system that contains the basic routines that help to transfer information between elements within the server computing device 114, such as during startup, is stored in the ROM 1012. The server computing device 114 further includes a mass storage device 1014. The mass storage device 1014 is able to store software instructions and data. Some or all of the components of the server computing device 114 can also be included in customer electronic computing device 102, mobile electronic computing device 104 and third-party electronic computing devices 120.

The mass storage device 1014 is connected to the CPU 1002 through a mass storage controller (not shown) connected to the system bus 1022. The mass storage device 1014 and its associated computer-readable data storage media provide non-volatile, non-transitory storage for the server computing device 114. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computing device 114.

According to various embodiments of the invention, the server computing device 114 may operate in a networked environment using logical connections to remote network devices through the network 106, such as a wireless network, the Internet, or another type of network. The server computing device 114 may connect to the network 106 through a network interface unit 1004 connected to the system bus 1022. It should be appreciated that the network interface unit 1004 may also be utilized to connect to other types of networks and remote computing systems. The server computing device 114 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the server computing device 114 can store software instructions and data. The software instructions include an operating system 1018 suitable for controlling the operation of the server computing device 114. The mass storage device 1014 and/or the RAM 1010 also store software instructions and software applications 1016, that when executed by the CPU 1002, cause the server computing device 114 to provide the functionality of the server computing device 114 discussed in this document. For example, the mass storage device 1014 and/or the RAM 1010 can store software instructions that, when executed by the CPU 1002, cause the server computing device 114 to display received data on the display screen of the server computing device 114.

Although various embodiments are described herein, those of ordinary skill in the art will understand that many modifications may be made thereto within the scope of the present disclosure. Accordingly, it is not intended that the scope of the disclosure in any way be limited by the examples provided.

1-12. (canceled)

13. A method implemented on an electronic computing device for determining a status of inventoried items in a home, the method comprising:
obtaining an inventory of items associated with the home;
obtaining purchase information for one or more of the items;
obtaining a maintenance history for one or more of the items;
monitoring an operational status of one or more of the items, the monitoring including obtaining, using at least one sensor, operational information from one or more of the items;
determining an individual health score for each of the items, including, for each item:
(i) assigning an initial point value;
(ii) assigning a repair point value based on a repair of the item;
(iii) determining a lifetime of the item;
(iv) dividing the initial point value by the lifetime to calculate an age factor;
(v) determining an age of the item;
(vi) multiplying the age by the age factor to calculate an age point value;
(vii) deducting the age point value and the repair point value from the initial point value to calculate a reduced point value;
(viii) assigning a weighting factor having a magnitude that is less than 100 percent, the magnitude being determined based on a type of the item, a sum of the weighting factors of the items being 100 percent; and
(ix) multiplying the reduced point value by the weighting factor to calculate the individual health score;
providing a first graphical interface displaying a first selectable graphical element and a second selectable graphical element;
providing, in response to a selection of the first selectable graphical element, a second graphical interface displaying a list of the items; and
providing, in response to a selection of the second selectable graphical element, a third graphical interface displaying an overall health score for the home, the overall health score being based on the purchase information, the individual health score for each of the items, the maintenance history and the operational status.

14. (canceled)

15. The method of claim 13, wherein the overall health score for the home includes a condition of the roof, siding, furnace, air conditioner and a plurality of appliances in the home.

16. (canceled)

17. The method of claim 13, further comprising:
determining whether one or more of the items needs repair;
accessing a maintenance record for the one or more items that needs repair; and
using the maintenance record to determine whether the one or more items should be replaced instead of repaired.

18. The method of claim 13, further comprising receiving a recommendation for a financial incentive to upgrade one of the items.

19. The method of claim 13, further comprising implementing a digital dashboard on the electronic computing device, the digital dashboard displaying maintenance information, warranty information and operational information for at least one of the one or more items.

20. An electronic computing device, comprising:
a processing unit; and
system memory, the system memory including instructions which, when executed by the processing unit, cause the electronic computing device to:
obtain an inventory of items associated with a home;
obtain a geolocation of the home;
monitor an operational status of one or more of the items, including obtaining, using at least one sensor, operational information from one or more of the items;
provide a graphical interface displaying at least one recommendation for replacement or upgrade of one or more of the items, wherein the at least one recommendation is based on:
whether there is an incentive program;
the operational status; and
a length of time an owner of the home intends to own the home, wherein the at least one recommendation uses a geo-tag for at least one of the items to determine a cost for replacement or upgrade of the at least one of the items;
calculate an individual health score for each of the items, including for each item:
(i) assign an initial point value;
(ii) assign a repair point value based on a repair of the item;
(iii) determine a lifetime of the item;
(iv) divide the initial point value by the lifetime to calculate an age factor;
(v) determine an age of the item;
(vi) multiply the age by the age factor to calculate an age point value;
(vii) deduct the age point value and the repair point value from the initial point value to calculate a reduced point value;
(viii) assign a weighting factor having a magnitude that is less than 100 percent, the magnitude being determined based on a type of the item, a sum of the weighting factors of the items being 100 percent; and
(ix) multiply the reduced point value by the weighting factor to calculate the individual health score;
apply another weighting factor to the geolocation of the home; and
calculate an overall health score for the home based on the individual health score of each item and the another weighting factor.
